(19) United States
(12) Patent Application Publication
(10) Pub. No.: US 2020/0141426 A1
(43) Pub. Date: May 7, 2020

(54) PULSE CONTROLLED SOLENOID VALVE WITH DUAL BALL DETENT

(71) Applicant: BorgWarner Inc., Auburn Hills, MI (US)

(72) Inventors: Tomas R. Diaz, Sterling Heights, MI (US); Jeffrey J. Waterstredt, Royal Oak, MI (US)

(21) Appl. No.: 16/180,673

(22) Filed: Nov. 5, 2018

(51) Int. Cl. F15B 13/01; F16K 31/06

(52) U.S. Cl. CPC F15B 13/01; F16K 31/0603

(57) ABSTRACT

A solenoid valve includes a housing defining an interior, a coil disposed in the interior, and an armature disposed in the interior and moveable between a first position and a second position during energization of the coil. A stationary member is fixedly coupled to the housing and has an inner surface defining a central bore, a first detent, and a second detent. A moveable member is disposed in the central bore, defines an aperture, and is moveable with the armature relative to the stationary member between the first and second positions. A biasing member is disposed in the aperture, and a locking member is biased by the biasing member toward and is engageable with the stationary member in the first detent to hold the moveable member in the first position and is engageable with the stationary member in the second detent to hold the moveable member in the second position.

### BACKGROUND OF THE INVENTION

### 1. Field of the Invention

The present invention generally relates to a solenoid valve and, more specifically, to a solenoid valve in a transmission.

### 2. Description of the Related Art

Conventional vehicles known in the art typically include an engine having a rotational output as a rotational input into a transmission such as an automatic transmission. The engine generates the rotational output which is selectively translated to the transmission which, in turn, translates rotational torque to one or more wheels of the vehicle. The transmission changes the rotational speed and torque generated by the engine through a series of predetermined gearsets, whereby changing between the gearsets enables the vehicle to travel at different vehicle speeds for a given engine speed.

Automatic transmissions are typically controlled using hydraulic fluid and a hydraulic system including a pump assembly, a valve housing having one or more solenoid valves, and an electronic controller. The pump assembly provides a source of fluid power to the solenoid valves of the valve housing which, in turn, are actuated by the electronic controller so as to selectively direct hydraulic fluid throughout the automatic transmission to control modulation of the rotational torque generated by the rotational output of the engine. The solenoid valves are also typically used to change between the gear sets of the automatic transmission, and may also be used to control the hydraulic fluid that is used to cool and/or lubricate various components of the transmission in operation.

The solenoid valves known in the art utilize electrical energy to operate. In particular, the solenoid valves comprise a solenoid actuator which converts electrical energy to mechanical energy through energization of a coil disposed in the solenoid actuator. During energization of the coil, an armature in the solenoid actuator moves from a first position toward a second position. Commonly, a biasing member biases the armature from the second position toward the first position to return the armature to the first position after the coil has been energized and the armature has moved to the second position. Therefore, to hold the armature in the second position, the solenoid actuator must continue to energize the coil unless costly and space consuming magnets are used to hold the armature in the second position. This continued energization of the coil required to hold the armature in the second position results in costly and unnecessary energy usage of the solenoid actuator. This continued energization of the coil required to hold the armature in the second position may also result in premature failure of the solenoid actuator.

Accordingly, it is desirable to provide an improved solenoid valve not having the disadvantages described above.

### SUMMARY OF THE INVENTION AND ADVANTAGES

The present invention provides a solenoid valve to control a flow of hydraulic fluid. The solenoid valve includes a housing extending along an axis between a first end and a second end spaced from the first end along the axis, with the housing defining an interior. A coil is disposed in the interior between the housing and the axis, and an armature is disposed in the interior between the coil and the axis. The armature is moveable between a first position and a second position different from the first position and spaced along the axis during energization of the coil.

The solenoid valve also includes a stationary member fixedly coupled to the housing and having an inner surface defining a central bore, a first detent, and a second detent spaced from the first detent along the axis. The solenoid valve also includes a moveable member disposed in the central bore of the stationary member and is moveable relative to the stationary member, with the moveable member coupled to the armature and defining an aperture. The moveable member is moveable with the armature between the first and second positions.

The solenoid valve further includes a biasing member disposed in the aperture of the moveable member and includes a locking member biased away from the axis by the biasing member toward the stationary member. The locking member is engageable with the stationary member in the first detent to hold the moveable member in the first position and is engageable with the stationary member in the second detent to hold the moveable member in the second position.

As such, the biasing member and the locking member allow the moveable member, and thus the armature, to be held in the first position through engagement with the first detent and to be held in the second position through engagement with the second detent without continued energization of the coil. The biasing member, the locking member, and the first and second detents also advantageously allow the solenoid valve to use less energy during operation without the use of magnets. Another advantage of the present invention is that the solenoid valve is prevented from premature failure due to repeated energization of the coil during operation of the solenoid valve.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1A is a cross-sectional view of a solenoid valve including a stationary member fixedly coupled to a housing and defining a central bore and a first detent, and with the solenoid valve including a moveable member disposed in the central bore in a first position and defining an aperture, with a biasing member disposed in the aperture and a locking member biased toward and engaged in the first detent to hold the moveable member in the first position;

FIG. 1B is a cross-sectional view of the solenoid valve, with the stationary member defining a second detent, with the moveable member in a second position, and with the locking member biased toward and engaged in the second detent to hold the moveable member in the second position;

FIG. 2A is a cross-sectional view of the solenoid valve, with the aperture defined completely through the moveable member, with the locking member being defined as a first locking member, and with the solenoid valve further including a second locking member biased toward and engaged in the first detent to hold the movable member in the first position;

FIG. 2B is a cross-sectional view of the solenoid valve, with the second locking member biased toward and engaged in the second detent to hold the moveable member in the second position;

FIG. 3A is a cross-sectional view of the solenoid valve, with the solenoid valve having a solenoid actuator, with the stationary member further defined as a collar, and with the moveable member further defined as an actuator rod in the first position;

FIG. 3B is a cross-sectional view of the solenoid valve, with the actuator rod of the solenoid actuator in the second position;

FIG. 4A is a cross-sectional view of the solenoid valve, with the solenoid valve having a valve assembly, with the stationary member further defined as a valve body, and with the moveable member further defined as a valve member in the first position;

FIG. 4B is a cross-sectional view of the solenoid valve, with the valve member of the valve assembly in the second position;

FIG. 5A is a cross-sectional view of the solenoid valve, with the first detent further defined as a first groove annularly recessed into an inner surface of the stationary member in the first position, and with the first and second locking members engaged with the first groove;

FIG. 5B is a cross-sectional view of the solenoid valve, with the second detent further defined as a second groove annularly recessed into the inner surface of the stationary member in the second position, and with the first and second locking members engaged with the second groove;

FIG. 6A is a cross-sectional view of the solenoid valve, with the solenoid valve including a valve biasing member coupled to an end of the valve member in the first position;

and

FIG. 6B is a cross-sectional view of the solenoid valve, with the valve member biased away from the second position toward the first position by the valve biasing member.

### DETAILED DESCRIPTION OF THE INVENTION

With reference to the Figures, wherein like numerals indicate like parts throughout the several views, a solenoid valve 10 to control a flow of hydraulic fluid is shown in conjunction with an automatic transmission for a vehicle having an engine that cooperates with the automatic transmission. The engine generates rotational torque which is selectively translated to the automatic transmission which, in turn, translates rotational torque to one or more wheels of the vehicle. It should be appreciated that the engine and/or automatic transmission could be of any suitable type, configured in any suitable way sufficient to generate and translate rotational torque so as to drive the vehicle, without departing from the scope of the present invention. It should also be appreciated that the solenoid valve 10 may be used in another system such as in a transfer case, a locking differential, or a disconnect clutch in a hybrid drivetrain. It should further be appreciated that the solenoid valve 10 may be used in other applications where it is necessary to modulate the engagement of a system and then leave the system engaged for a period of time.

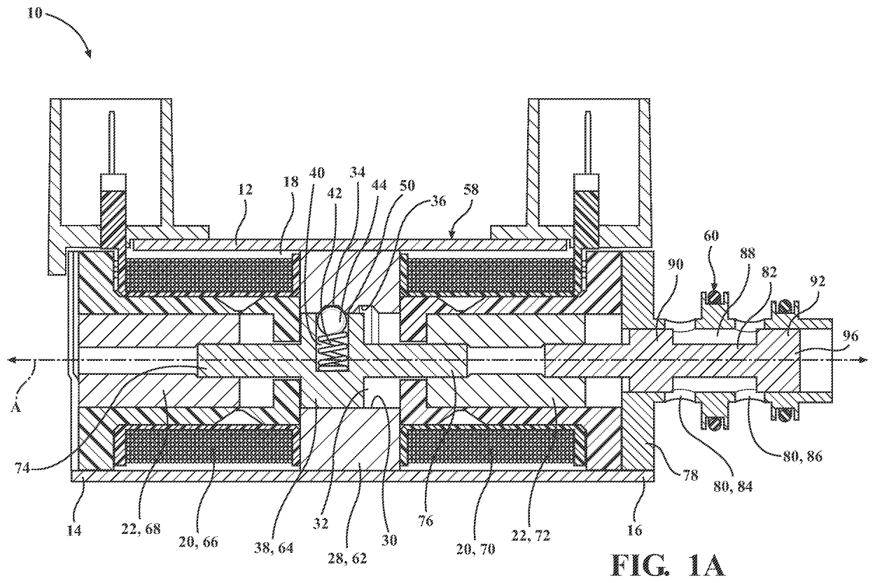

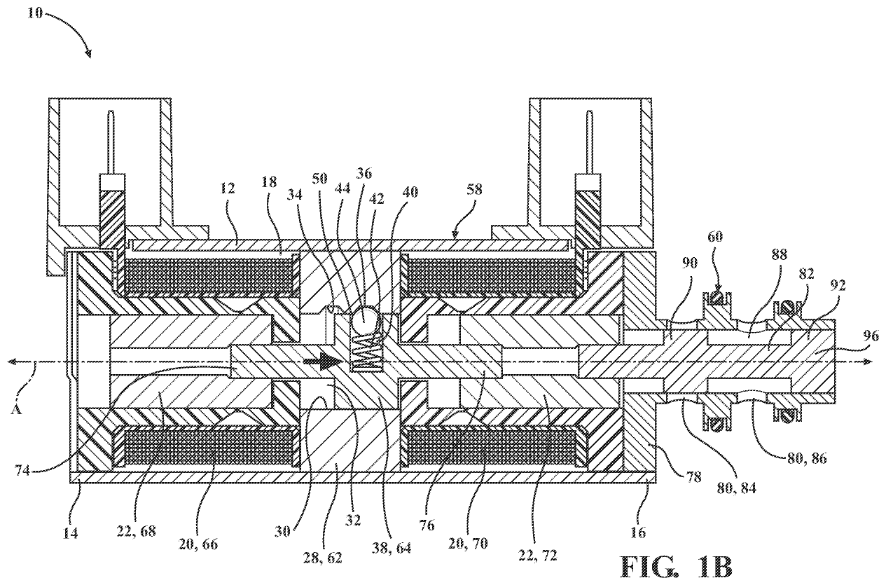

With reference to FIGS. 1A-6B, the solenoid valve 10 includes a housing 12 extending along an axis A between a first end 14 and a second end 16 spaced from the first end 14 along the axis A. The housing 12 defines an interior 18. A coil 20 is disposed in the interior 18 between the housing 12 and the axis A, and an armature 22 is disposed in the interior 18 between the coil 20 and the axis A. During energization of the coil 20, the armature 22 is moveable between a first position, as shown in FIGS. 1A, 2A, 3A, 4A, 5A, and 6A, and a second position different from the first position and spaced along the axis A, as shown in FIGS. 1B, 2B, 3B, 4B, 5B, and 6B.

The solenoid valve 10 further includes a stationary member 28 fixedly coupled to the housing 12. The stationary member 28 has an inner surface 30 defining a central bore 32, a first detent 34, and a second detent 36 spaced from the first detent 34 along the axis A. The solenoid valve 10 also includes a moveable member 38 disposed in the central bore 32 of the stationary member 28 and moveable relative to the stationary member 28. The moveable member 38 is coupled to the armature 22 and defines an aperture 40, and the moveable member 38 is moveable with the armature 22 between the first and second positions. A biasing member 42 is disposed in the aperture 40 of the moveable member 38, and a locking member 44 is biased away from the axis A by the biasing member 42 toward the stationary member 28. The locking member 44 is engageable with the stationary member 28 in the first detent 34 to hold the moveable member 38 in the first position, and the locking member 44 is engageable with the stationary member 28 in the second detent 36 to hold the moveable member 38 in the second position.

The energization of the coil 20 may be a pulse of an impulse current over a short period of time. The impulse current may be enough to move the moveable member 38 from the first position where the locking member 44 is engaged in the first detent 34 to the second position where the locking member 44 is engaged in the second detent 36. It is to be appreciated that the amount of current in the impulse current is dependent upon the properties of the biasing member 42, particularly the spring constant of the biasing member 42, and the depth of the first and second detents 34, 36, among other factors. It is to be appreciated that the impulse current required to move the moveable member 38 from the first position to the second position will vary based upon the properties of the biasing member 42, and the depth of the first and second detents 34, 36, among other factors.

In one embodiment, the first detent 34 is further defined as a first groove 46 annularly recessed into the inner surface 30 of the stationary member 28, and the second detent 36 is further defined as a second groove 48 annularly recessed into the inner surface 30 of the stationary member 28.

With reference to FIGS. 1A, 1B, and 3A-4B, where the solenoid valve includes the moveable member, the aperture 40 is defined only partially through the moveable member 38 such that the moveable member 38 defines a first opening 50. The locking member 44 is disposed in the first opening 50 and biased away from the axis A by the biasing member 42 toward the stationary member 28.

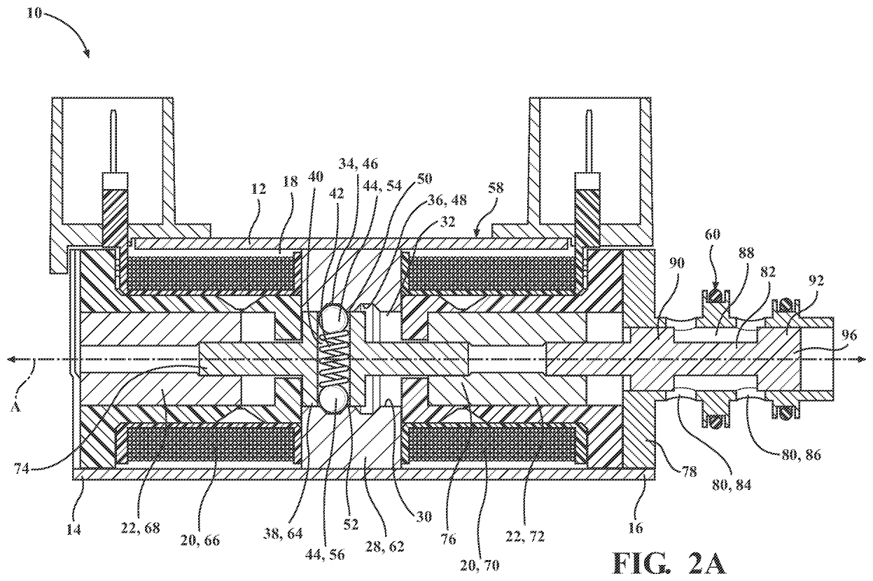

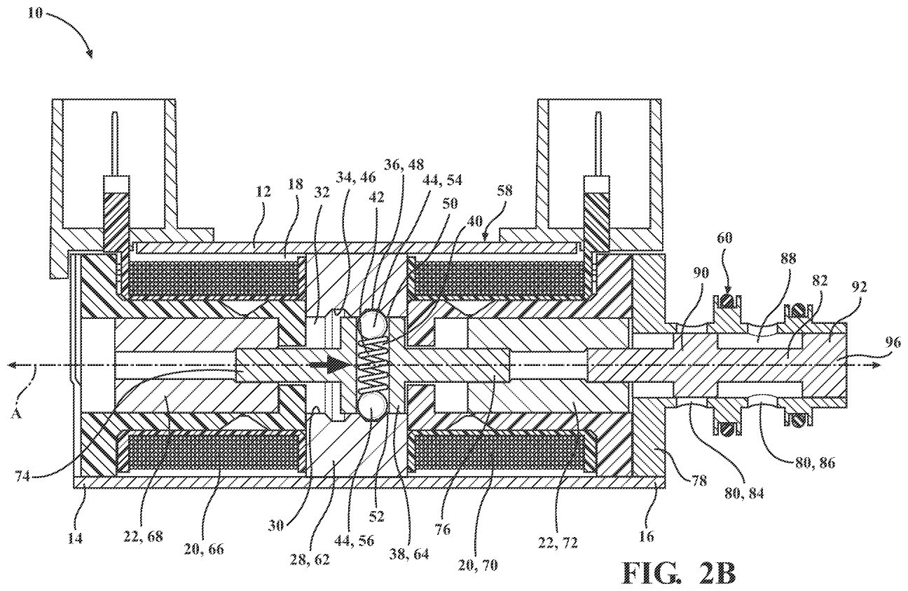

With reference to FIGS. 2A, 2B, and 5A-6B, the aperture 40 is defined completely through the moveable member 38 such that the moveable member 38 defines the first opening 50 and a second opening 52 radially opposite the first opening 50. In this embodiment, the locking member 44 is further defined as a first locking member 54 disposed in the first opening 50, and the solenoid valve 10 further includes a second locking member 56 disposed in the second opening 52 and biased away from the axis A by the biasing member 42 toward the stationary member 28. In this embodiment, the second locking member 56 is engageable with the stationary member 28 in the first detent 34 to hold the moveable member 38 in the first position and is engageable with the stationary member 28 in the second detent 36 to hold the moveable member 38 in the second position.

In one embodiment, the stationary member 28 is integral with the housing 12. In another embodiment, the stationary member 28 is discrete from the housing 12. In yet another embodiment, the stationary member 28 is formed separately from the housing 12 and later joined with the housing 12 to become integral with the housing 12. For example, the stationary member 28 may be press-fit, welded, or otherwise joined with the housing 12 to become integral with the housing 12.

While depicted as a ball in FIGS. 1A-6D, it is to be appreciated that the locking member 44 may be other configurations such as oval, bullet, cylindrical, or any other shape capable of engaging the first and second detents 34, 36 to hold the moveable member 38 in the first and second positions.

As such, the biasing member 42 and the locking member 44 allow the moveable member 38, and thus the armature 22, to be held in the first position through engagement with the first detent 34 and to be held in the second position through engagement with the second detent 36 without continued energization of the coil 20. The biasing member 42, the locking member 44, and the first and second detents 34, 36 advantageously allow the solenoid valve 10 to use less energy during operation without the use of magnets. Another advantage of the present invention is that the solenoid valve 10 is prevented from premature failure due to repeated energization of the coil 20 during operation of the solenoid valve 10.

The solenoid valve 10 may include a solenoid actuator 58 and a valve assembly 60. The solenoid actuator may include the housing 12 extending along the axis A between the first end 14 and the second end 16 spaced from the first end 14 along the axis A and defining the interior 18. The solenoid valve 10 may also include the coil 20 disposed in the interior 18 between the housing 12 and the axis A, and the armature 22 disposed in the interior 18 between the coil 20 and the axis A. The armature 22 may be moveable between the first position and the second position different from the first position and spaced along the axis A during energization of the coil 20. The valve assembly 60 may be coupled to the solenoid actuator 58 to control the flow of hydraulic fluid. The stationary member 28 and the moveable member 38 may be included in the solenoid actuator 58, or may be included in the valve assembly 60.

In the embodiment where the solenoid actuator 58 includes the stationary member 28 and the moveable member 38 as shown in FIGS. 1A-3B, 5A and 5B, the stationary member 28 is further defined as a collar 62 disposed in the interior 18 of the housing 12, fixedly coupled to the housing 12, and having the inner surface 30 defining the central bore 32, the first detent 34, and the second detent 36 spaced from the first detent 34 along the axis A. In this embodiment, the moveable member 38 is further defined as an actuator rod 64 disposed in the interior 18 of the housing 12, disposed in the central bore 32 of the collar 62, and moveable relative to the collar 62. The actuator rod 64 may be coupled to the armature 22 and may define the aperture 40, and the actuator rod 64 may be moveable with the armature 22 between the first and second positions. The biasing member 42 may be disposed in the aperture 40 of the actuator rod 64, and the locking member 44 may be biased away from the axis A by the biasing member 42 toward the collar 62. The locking member 44 may be engageable with the collar 62 in the first detent 34 to hold the actuator rod 64 in the first position and may be engageable with the collar 62 in the second detent 36 to hold the actuator rod 64 in the second position.

In one embodiment, as shown in FIGS. 1A-2B, the coil 20 of the solenoid actuator 58 is further defined as a first coil 66 and the armature 22 is further defined as a first armature 68. The solenoid actuator 58 may further include a second coil 70 disposed in the interior 18 between the housing 12 and the axis A, and may further include a second armature 72 disposed in the interior 18 between the second coil 70 and the axis A. The second armature 72 may be moveable between the second position and the first position during energization of the second coil 70.

The actuator rod 64 may have a first end 74 coupled to the first armature 68 and a second end 76 coupled to the second armature 72. In other words, the actuator rod 64 and the collar 62 may be disposed between the first and second coils 66, 70. The actuator rod 64 may be moveable from the first position, as shown in FIGS. 1A and 2A, toward the second position, as shown in FIGS. 1B and 2B, by the first armature 68 during energization of the first coil 66. More specifically, the impulse current is pulsed through the first coil 66 which generates magnetic flux and which causes a force on the first armature 68 to move the first armature 68, and thus the actuator rod 64, from the first position toward the second position. Additionally, the actuator rod 64 may be moveable from the second position, as shown in FIGS. 1B and 2B, toward the first position, as shown in FIGS. 1A and 2A, by the second armature 72 during energization of the second coil 70. More specifically, the impulse current is pulsed through the second coil 70 which generates magnetic flux and which causes a force on the second armature 72 to move the second armature 72, and thus the actuator rod 64, from the second position toward the first position. When the solenoid actuator 58 includes the first and second coils 66, 70, the solenoid valve 10 may be referred to as a dual solenoid valve, a double solenoid valve, or an opposing solenoid valve.

In the embodiment where the solenoid actuator 58 includes the collar 62 as shown in FIGS. 1A-3B, 5A and 5B, the first detent 34 is further defined as the first groove 46 annularly recessed into the inner surface 30 of the collar 62, and the second detent 36 is further defined as the second groove 48 annularly recessed into the inner surface 30 of the collar 62.

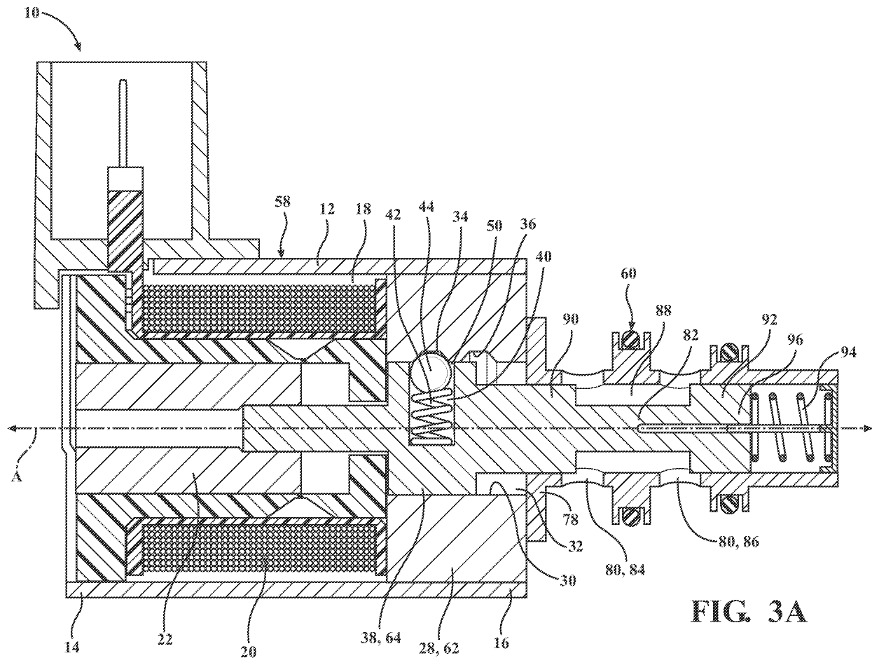

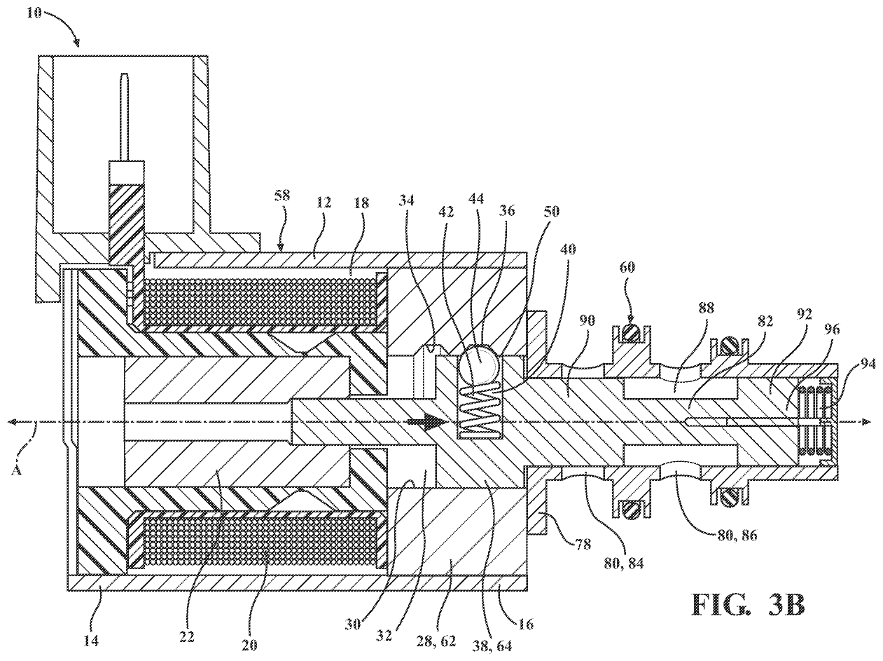

With reference to FIGS. 1A, 1B, 3A, and 3B, where the solenoid actuator 58 includes the actuator rod 64, the aperture 40 is defined only partially through the actuator rod 64 such that the actuator rod 64 defines the first opening 50. The locking member 44 is disposed in the first opening 50 and biased away from the axis A by the biasing member 42 toward the collar 62.

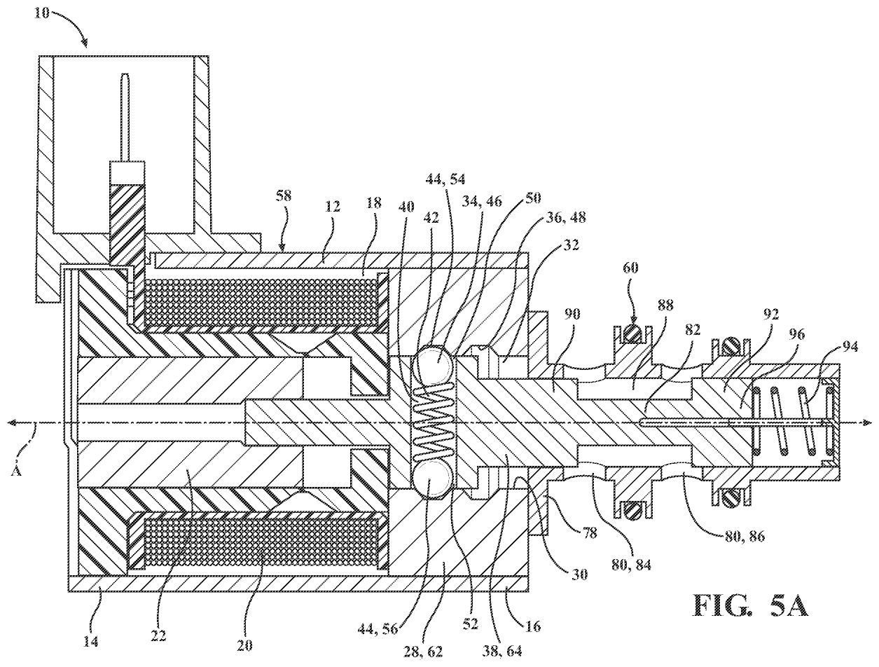

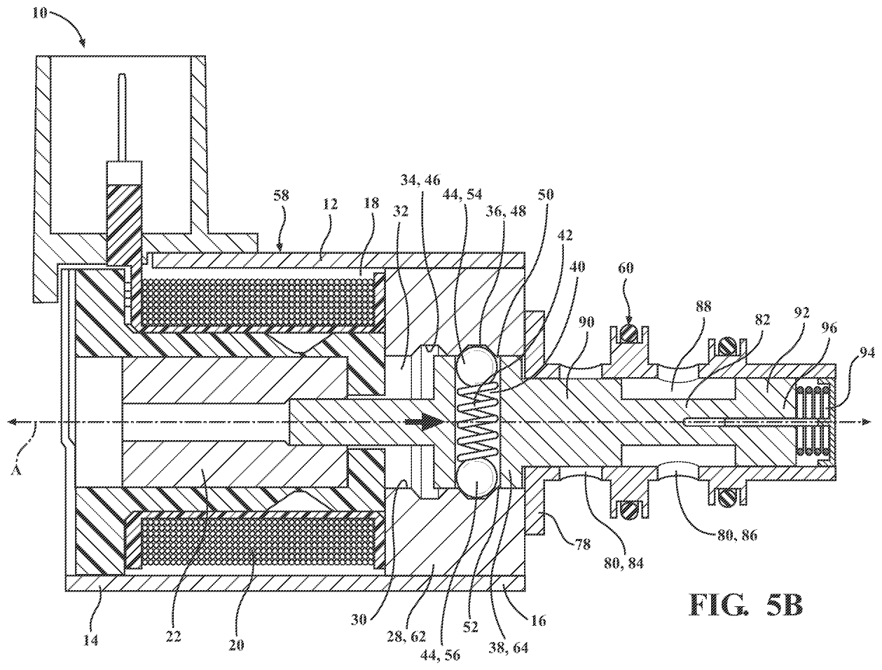

Additionally, in the embodiment where the solenoid actuator 58 includes the actuator rod 64 as shown in FIGS. 2A, 2B, 5A and 5B, the aperture 40 is defined completely through the actuator rod 64 such that the actuator rod 64 defines the first opening 50 and the second opening 52 radially opposite the first opening 50. The locking member 44 is further defined as the first locking member 54 disposed in the first opening 50, and the solenoid actuator 58 further comprises the second locking member 56 disposed in the second opening 52 and biased away from the axis A by the biasing member 42 toward the collar 62.

In one embodiment, the collar 62 is integral with the housing 12. In another embodiment, the collar 62 is discrete from the housing 12. In yet another embodiment, the collar 62 is formed separately from the housing 12 and later joined with the housing 12 to become integral with the housing 12. For example, the collar 62 may be press-fit, welded, or otherwise joined with the housing 12 to become integral with the housing 12.

While depicted as a concentric band in FIGS. 1A-3B, 5A, and 5B, it is to be appreciated that the collar 62 may be other configurations such as a partially concentric band, a polygonal configuration approximating a concentric band, or any other shape capable of being fixedly coupled to the housing 12 and capable of defining the first and second detents 34, 36.

One advantage of the solenoid actuator 58 including the collar 62 and the actuator rod 64 is a decrease in the amount of energy necessary to hold the actuator rod 64 in either the first or second positions during operation of the solenoid actuator 58 because continued energization of the coil 20 is unnecessary after the impulse current is pulsed through the coil 20. Continued energization of the coil 20 is unnecessary because the locking member 44 engages either the first or second detents 34, 36 to hold the armature 22 in the first or second positions after the impulse current is pulsed through the coil 20.

Additionally, in the embodiments where the solenoid actuator 58 includes the second coil 70 and the second armature 72, the solenoid valve 10 operates in either the first or second positions without requiring any energization of either the first or second coils 66, 70 whatsoever, allowing the solenoid valve 10 to be completely de-energized during extended periods of operation of the solenoid valve 10 in either the first or second positions without movement between the first and second positions. In other words, the solenoid valve 10 may be completely de-energized during extended periods of operation of the solenoid valve 10 during steady-state where the solenoid valve 10 operates in either the first position without moving toward the second position or in the second position without moving toward the first position.

Another advantage of the solenoid actuator 58 including the collar 62 and the actuator rod 64 is an increased lifespan of the solenoid valve 10 and prevention from premature failure due to repeated energization of the coil 20 during operation of the solenoid valve 10.

Yet another advantage of the solenoid actuator 58 including the collar 62 and the actuator rod 64 is an increase in modular ability of the solenoid valve 10. For example, the solenoid actuator 58 may be incorporated into a larger hydraulic assembly instead of into a solenoid valve 10 while still retaining the above advantages.

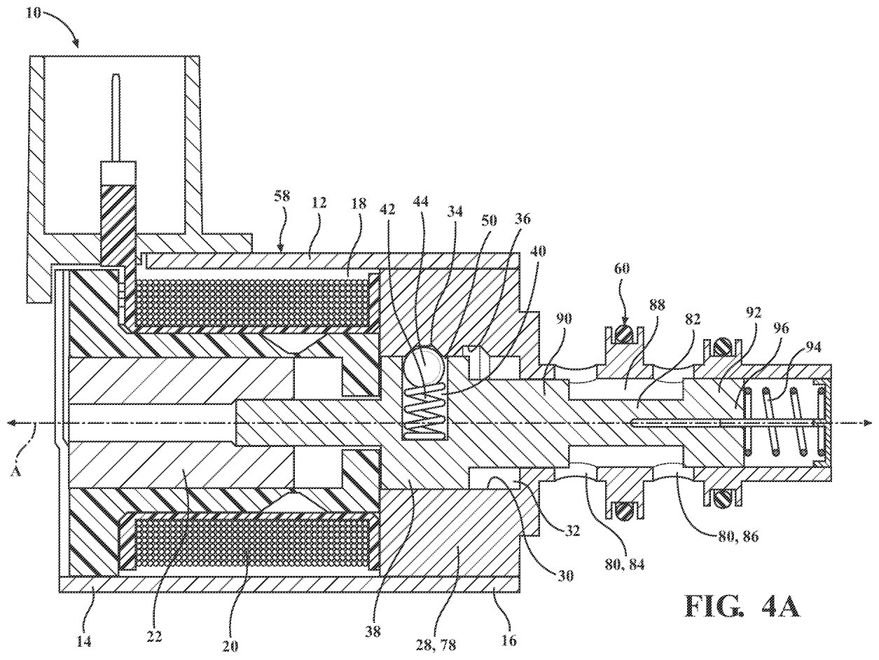

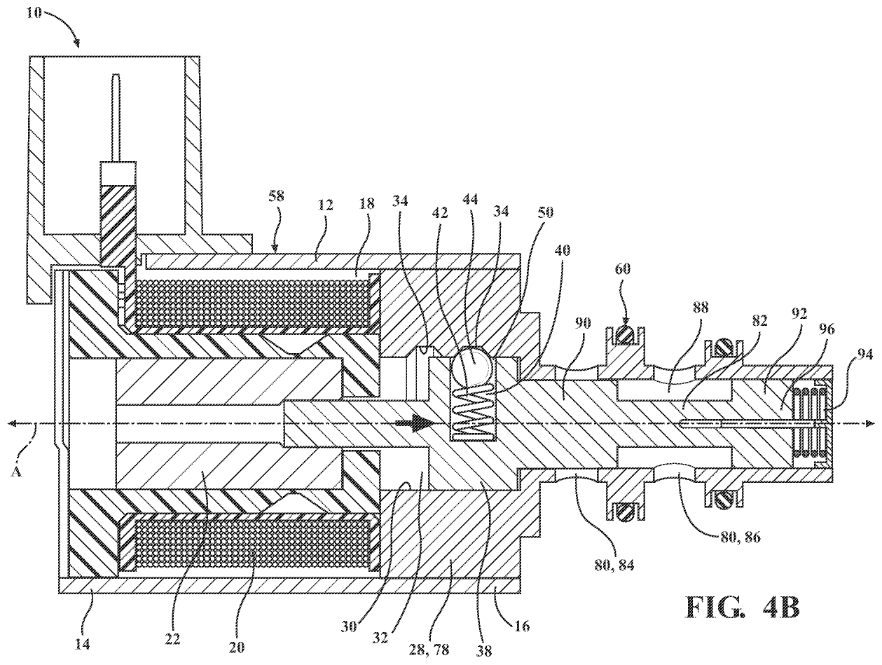

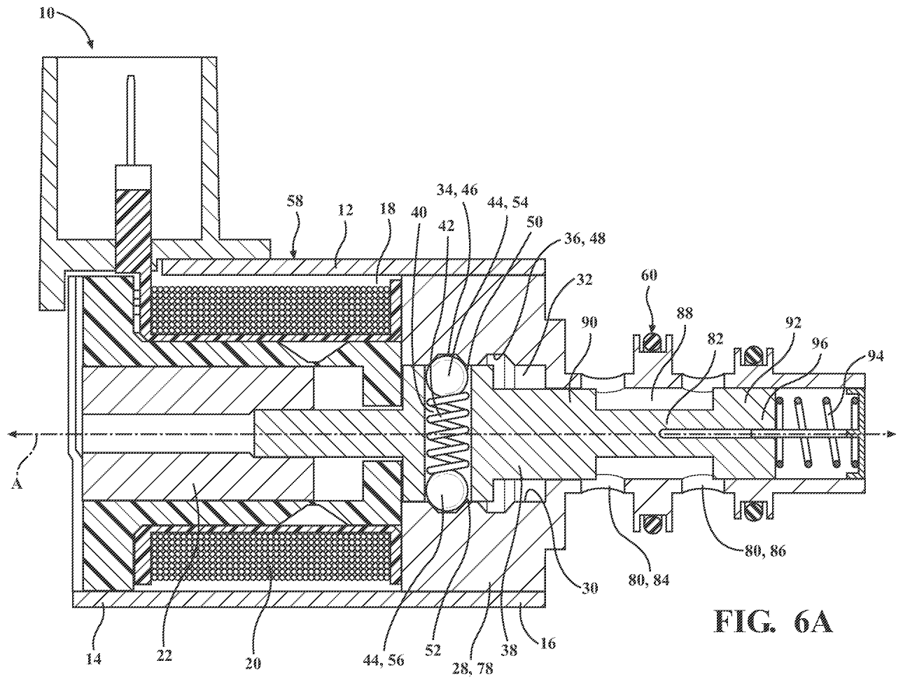

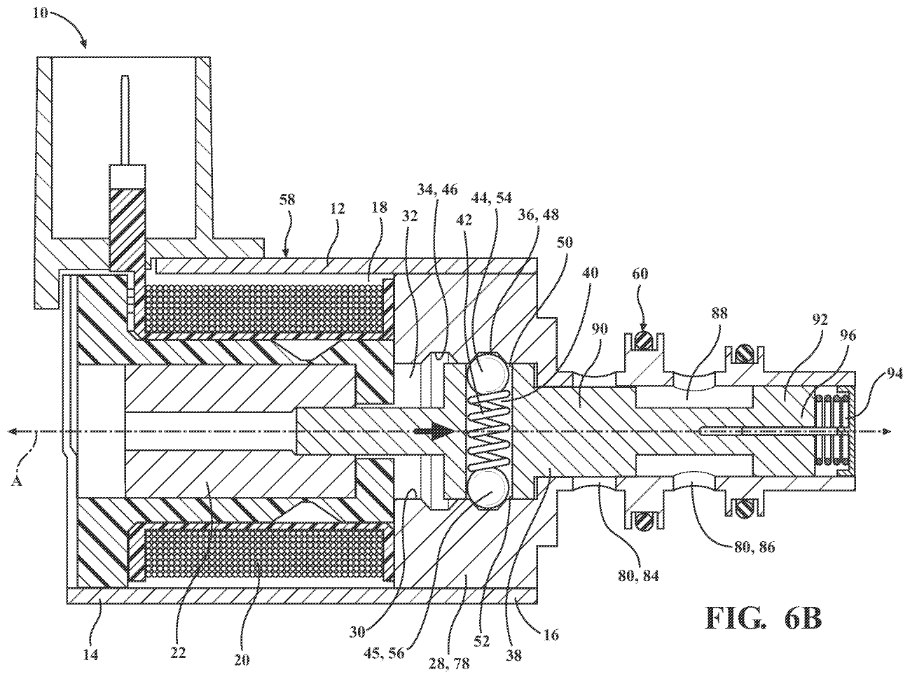

In the embodiment where the valve assembly 60 includes the stationary member 28 and the moveable member 38 as shown in FIGS. 4A, 4B, 6A, and 6B, the stationary member may be adapted to be fixedly coupled to the housing 12 and may have the inner surface 30 defining the central bore 32, the first detent 34, and the second detent 36 spaced from the first detent 34 along the axis A. The valve assembly 60 may have the moveable member 38 disposed in the central bore 32 of the stationary member 28 and may be moveable relative to the stationary member 28. The moveable member 38 may be adapted to be coupled to the armature 22 and may define the aperture 40. The biasing member 42 may be disposed in the aperture 40 of the moveable member 38, and the locking member 44 may be biased away from the axis A by the biasing member 42 toward the stationary member 28. The locking member 44 may be engageable with the stationary member 28 in the first detent 34 to hold the moveable member 38 in the first position, and the locking member 44 may be engageable with the stationary member 28 in the second detent 36 to hold the moveable member 38 in the second position.

In the embodiment where the valve assembly 60 includes the stationary member 28 and the moveable member 38 as shown in FIGS. 4A, 4B, 6A, and 6B, the stationary member 28 may be further defined as a valve body 78 having a plurality of ports 80, and the moveable member 38 may be further defined as a valve member 82 configured to selectively block the plurality of ports 80 to control the flow of hydraulic fluid.

More specifically, the valve body 78 may define the plurality of ports 80 to be first ports 84 circumferentially spaced about the axis A and second ports 86 spaced from the first ports 84 along the axis A and circumferentially spaced about the axis A. The first and second ports 84, 86 may be in fluid communication with an internal passage 88 and with the transmission to selectively change the gearsets of the transmission. The valve member 82 may be disposed in the internal passage 88, may extend along the axis A, and may have a first spool 90 extending radially away from the axis A and a second spool 92 spaced from the first spool 90 along the axis A and extending radially away from the axis A.

In the first position, the first spool 90 may only partially block the first ports 84 and the second spool 92 may only partially block the second ports 86. As such, the flow of hydraulic fluid is free to move either from the first ports 84, through the internal passage 88, and out of the second ports 86 or from the second ports 86, through the internal passage 88, and out of the first ports 84. The direction of the flow of hydraulic fluid is dependent upon the pressure of the hydraulic fluid at the first ports 84 and the pressure of the hydraulic fluid at the second ports 86.

In the second position, the first spool 90 may completely block the first ports 84 and the second spool 92 may not block the second ports 86 whatsoever. As such, the flow of hydraulic flow is blocked from moving from the first ports 84, through the internal passage 88, and out of the second ports 86 or from the second ports 86, through the internal passage 88, and out of the first ports 84. Any flow of hydraulic fluid through the internal passage 88 is blocked in the second position, allowing a pressure gradient to be established between the pressure of the hydraulic fluid at the first ports 84 and the pressure of the hydraulic fluid at the second ports 86.

The solenoid valve may also further include a valve biasing member 94 coupled to an end 96 of the valve member 82 or to either the first or second ends 74, 76 of the actuator rod 64. The valve biasing member 94 may bias the valve member 82 or actuator rod 64 away from the second position toward the first position, or may bias the valve member 82 or actuator rod 64 away from the first position toward the second position. The valve biasing member 94 may bias the valve member 82 in the embodiment with the valve body 78, as shown in FIGS. 4A, 4B, 6A, and 6B, or may bias the actuator rod in the embodiment with the collar 62, as shown in FIGS. 3A, 3B, 5A, and 5B.

In addition to the valve biasing member 94, the pressure from the flow of hydraulic fluid may also assist in moving the valve member 82 or the actuator rod 64 away from the second position toward the first position. As such, the spring constant required of the valve biasing member 94 is dependent on the pressure from the flow of hydraulic fluid. In addition to the pressure from the flow of hydraulic fluid, it is to be appreciated that the spring constant required to bias the valve member 82 or the actuator rod 64 from the second position to the first position is dependent upon the size and weight of the valve member 82 or the actuator rod 64, the spring constant of the biasing member 42, and the depth of the first and second detents 34, 36, among other factors.

In the embodiment where the valve assembly 60 includes the valve body 78 as shown in FIGS. 4A, 4B, 6A, and 6B, the first detent 34 is further defined as the first groove 46 annularly recessed into the inner surface 30 of the valve body 78, and the second detent 36 is further defined as the second groove 48 annularly recessed into the inner surface 30 of the valve body 78.

With reference to FIGS. 4A and 4B, where the valve assembly 60 includes the valve member 82, the aperture 40 is defined only partially through the valve member 82 such that the valve member 82 defines the first opening 50. The locking member 44 is disposed in the first opening 50 and biased away from the axis A by the biasing member 42 toward the valve body 78.

Additionally, in the embodiment where the valve assembly 60 includes the valve member 82 as shown in FIGS. 6A and 6B, the aperture 40 is defined completely through the valve member 82 such that the valve member 82 defines the first opening 50 and the second opening 52 radially opposite the first opening 50. The locking member 44 is further defined as the first locking member 54 disposed in the first opening 50, and the valve assembly 60 further includes the second locking member 56 disposed in the second opening 52 and biased away from the axis A by the biasing member 42 toward the valve body 78.

In one embodiment, the valve body 78 is integral with the housing 12. In another embodiment, the valve body 78 is discrete from the housing 12. In yet another embodiment, the valve body 78 is formed separately from the housing 12 and later joined with the housing 12 to become integral with the housing 12. For example, the valve body 78 may be press-fit, welded, or otherwise joined with the housing 12 to become integral with the housing 12.

One advantage of the valve assembly 60 including the stationary member 28 and the moveable member 38 is a decrease in the amount of energy necessary to hold the valve member 82 in either the first or second positions during operation of the solenoid valve 10 because continued energization of the coil 20 at typical amounts of energization is unnecessary after the impulse current is pulsed through the coil 20. As such, the solenoid valve 10 may operate in the second position while requiring less energization of the coil 20, allowing extended periods of steady state operation of the solenoid valve 10.

Another advantage of the valve assembly 60 including the stationary member 28 and the moveable member 38 is an increased lifespan of the solenoid valve 10 and prevention from premature failure due to repeated energization of the coil 20 during operation of the solenoid valve 10.

Yet another advantage of the valve assembly 60 including the stationary member 28 and the moveable member 38 is an increase in modular ability of the solenoid valve 10. For example, the valve assembly 60 may be incorporated with any design of the solenoid actuator 58 to form the solenoid valve 10 while still retaining the above advantages.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A solenoid valve to control a flow of hydraulic fluid, said solenoid valve comprising:
a housing extending along an axis between a first end and a second end spaced from said first end along said axis and defining an interior;
a coil disposed in said interior between said housing and said axis;
an armature disposed in said interior between said coil and said axis, with said armature moveable between a first position and a second position different from said first position and spaced along said axis during energization of said coil;
a stationary member fixedly coupled to said housing and having an inner surface defining a central bore, a first detent, and a second detent spaced from said first detent along said axis;
a moveable member disposed in said central bore of said stationary member and moveable relative to said stationary member, with said moveable member coupled to said armature and defining an aperture, and with said moveable member moveable with said armature between said first and second positions;
a biasing member disposed in said aperture of said moveable member; and
a locking member biased away from said axis by said biasing member toward said stationary member;
wherein said locking member is engageable with said stationary member in said first detent to hold said moveable member in said first position and is engageable with said stationary member in said second detent to hold said moveable member in said second position.

2. The solenoid valve as set forth in claim 1, wherein said first detent is further defined as a first groove annularly recessed into said inner surface of said stationary member, and wherein said second detent is further defined as a second groove annularly recessed into said inner surface of said stationary member.

3. The solenoid valve as set forth in claim 1, wherein said aperture is defined completely through said moveable member such that said moveable member defines a first opening and a second opening radially opposite said first opening, wherein said locking member is further defined as a first locking member disposed in said first opening, and wherein said solenoid valve further comprises a second locking member disposed in said second opening and biased away from said axis by said biasing member toward said stationary member.

4. The solenoid valve as set forth in claim 3, wherein said second locking member is engageable with said stationary member in said first detent to hold said moveable member in said first position and is engageable with said stationary member in said second detent to hold said moveable member in said second position.

5. The solenoid valve as set forth in claim 1, wherein said stationary member is integral with said housing.

6. The solenoid valve as set forth in claim 1, wherein said stationary member is further defined as a collar disposed in said interior of said housing, and wherein said moveable member is further defined as an actuator rod disposed in said interior of said housing.

7. The solenoid valve as set forth in claim 6, wherein said coil is further defined as a first coil and said armature is further defined as a first armature, and wherein said solenoid valve further comprises a second coil disposed in said interior between said housing and said axis, and further comprises a second armature disposed in said interior between said second coil and said axis, with said second armature moveable between said second position and said first position during energization of said second coil.

8. The solenoid valve as set forth in claim 7, wherein said actuator rod has a first end coupled to said first armature and a second end coupled to said second armature, and wherein said actuator rod is moveable from said first position toward said second position by said first armature during energization of said first coil, and is moveable from said second position toward said first position by said second armature during energization of said second coil.

9. The solenoid valve as set forth in claim 1, wherein said stationary member is further defined as a valve body having a plurality of ports, and wherein said moveable member is further defined as a valve member configured to selectively block said plurality of ports to control the flow of hydraulic fluid.

10. The solenoid valve as set forth in claim 9 further comprising a valve biasing member coupled to an end of said valve member, with said valve member biased away from said second position toward said first position by said valve biasing member.

11. A solenoid actuator for a solenoid valve, the solenoid actuator comprising:
a housing extending along an axis between a first end and a second end spaced from said first end along said axis and defining an interior;
a coil disposed in said interior between said housing and said axis;
an armature disposed in said interior between said coil and said axis, with said armature moveable between a first position and a second position different from said first position and spaced along said axis during energization of said coil;
a collar disposed in said interior of said housing, fixedly coupled to said housing, and having an inner surface defining a central bore, a first detent, and a second detent spaced from said first detent along said axis;
an actuator rod disposed in said interior of said housing, disposed in said central bore of said collar, and moveable relative to said collar, with said actuator rod coupled to said armature and defining an aperture, and with said actuator rod moveable with said armature between said first and second positions;
a biasing member disposed in said aperture of said actuator rod; and
a locking member biased away from said axis by said biasing member toward said collar;
wherein said locking member is engageable with said collar in said first detent to hold said actuator rod in said first position and is engageable with said collar in said second detent to hold said actuator rod in said second position.

12. The solenoid actuator as set forth in claim 11, wherein said coil is further defined as a first coil and said armature is further defined as a first armature, and wherein said solenoid actuator further comprises a second coil disposed in said interior between said housing and said axis and further comprises a second armature disposed in said interior between said second coil and said axis, with said second armature moveable between said second position and said first position during energization of said second coil.

13. The solenoid actuator as set forth in claim 12, wherein said actuator rod has a first end coupled to said first armature and a second end coupled to said second armature, and wherein said actuator rod is moveable from said first position toward said second position by said first armature during energization of said first coil and is moveable from said second position toward said first position by said second armature during energization of said second coil.

14. The solenoid actuator as set forth in claim 11, wherein said first detent is further defined as a first groove annularly recessed into said inner surface of said collar, and wherein said second detent is further defined as a second groove annularly recessed into said inner surface of said collar.

15. The solenoid actuator as set forth in claim 11, wherein said aperture is defined completely through said actuator rod such that said actuator rod defines a first opening and a second opening radially opposite said first opening, wherein said locking member is further defined as a first locking member disposed in said first opening, and wherein said solenoid actuator further comprises a second locking member disposed in said second opening and biased away from said axis by said biasing member toward said collar.

16. A valve assembly for a solenoid valve to control a flow of hydraulic fluid, with the solenoid valve including a housing extending along an axis between a first end and a second end spaced from the first end along the axis and defining an interior, and an armature disposed in the interior between the housing and the axis, said valve assembly comprising:
a stationary member adapted to be fixedly coupled to the housing and having an inner surface defining a central bore, a first detent, and a second detent spaced from said first detent along the axis;
a moveable member disposed in said central bore of said stationary member and moveable relative to said stationary member, with said moveable member adapted to be coupled to the armature and defining an aperture;
a biasing member disposed in said aperture of said moveable member; and
a locking member biased away from the axis by said biasing member toward said stationary member,
wherein said locking member is engageable with said stationary member in said first detent to hold said moveable member in said first position and is engageable with said stationary member in said second detent to hold said moveable member in said second position.

17. The valve assembly as set forth in claim 15, wherein said stationary member is further defined as a valve body having a plurality of ports, and wherein said moveable member is further defined as a valve member configured to selectively block said plurality of ports to control the flow of hydraulic fluid.

18. The valve assembly as set forth in claim 16 further comprising a valve biasing member coupled to an end of said valve member, with said valve member biased away from said second position toward said first position by said valve biasing member.

19. The valve assembly as set forth in claim 17, wherein said first detent is further defined as a first groove annularly recessed into said inner surface of said valve body, and wherein said second detent is further defined as a second groove annularly recessed into said inner surface of said valve body.

20. The valve assembly as set forth in claim 16, wherein said aperture is defined completely through said moveable member such that said moveable member defines a first opening and a second opening radially opposite said first opening, wherein said locking member is further defined as a first locking member disposed in said first opening, and wherein said valve assembly further comprises a second locking member disposed in said second opening and biased away from said axis by said biasing member toward said stationary member.
